(19) United States
(12) Patent Application Publication
(10) Pub. No.: US 2022/0256417 A1
(43) Pub. Date: Aug. 11, 2022

(54) SERVICE CONTINUITY ACROSS NETWORK SLICES

(71) Applicant: NEC Corporation, Minato-ku, Tokyo (JP)

(72) Inventors: Iskren IANEV, Tokyo (JP); Toshiyuki TAMURA, Tokyo (JP)

(73) Assignee: NEC Corporation, Minato-ku, Tokyo (JP)

(21) Appl. No.: 17/630,001

(22) PCT Filed: Jun. 24, 2021
(86) PCT No.: PCT/JP2021/023954

§ 371 Date: Jan. 25, 2022

(30) Foreign Application Priority Data
Jul. 17, 2020 (EP) 20186525.0

(51) Int. Cl. H04W 36/08; H04W 36/00

(52) U.S. Cl. CPC H04W 36/08; H04W 36/0011

(57) ABSTRACT

This disclosure addresses the service continuity across network slices for mobile terminals in connected mode. It proposes solutions that allow mobile terminal users to prioritize a service or a type of service that would improve the service continuity across network slices for user preferred services.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to network slices and service continuity in the so-called ‘5G’ (or ‘Next Generation’) systems.

### ABBREVIATIONS

3GPP: 3rd Generation Partnership Project

5G: 5th Generation

5GC: 5G Core Network

5GS: 5G System

5G-AN: 5G Access Network

AMF: Access and Mobility Management Function

AS: Application Server

CAG: Closed Access Group

gNB: Next generation Node

GSMA: Global System for Mobile Communications

NAS: Non-Access Stratum

NG-RAN: Next Generation Radio Access Network

NR: New Radio

NSSAI: Network Slice Selection Assistance Information

PDU: Protocol Data Unit

PLMN: Public land mobile network

RACH: Random Access Channel

RAN: Radio Access Network

RAT: Radio Access Technology

RRC: Radio Resource Control

S-NSSAI: Single Network Slice Selection Assistance Information

SMF: Session Management Function

TA: Tracking Area

UDM: Unified Data Management

UDR: Unified Data Repository

UE: User Equipment

URLLC: Ultra Reliable and Low Latency Communications

For the purposes of the present document, the terms and definitions given in 3GPP Technical Report (TR) 21.905 [NPL1] and the following apply. A term defined in the present document takes precedence over the definition of the same term, if any, in 3GPP TR 21.905 [NPL].

### BACKGROUND ART

Network slicing features defined in 3GPP release 15 and release 16 enable a great variety of communication services for operators and verticals alike. To enhance the commercial viability of Network Slicing, GSMA 5GJA has introduced in document NG. 116 the concept of Generic Slice Template (GST) [NPL 4] from which several Network Slice Types descriptions can be derived. Some of the parameters in the GST point explicitly to the definition of parameters and bounds on the service delivered to the end customer. However, the enforcement of some of these bounds and parameters are not supported by the 5GS yet.

The SA2 Study on Enhancement of Network Slicing Phase 2 aims at identifying the gaps that need to be filled in providing support for the GST parameters enforcement and the suitable solution to address these gaps.

RAN follows the progress of SA2 study on enhanced network slicing and RAN has agreed their own study item on RAN slicing enhancement. The aim is to investigate enhancements on RAN support of network slicing with the following objectives:
1. Study mechanisms to enable UE fast access to the cell supporting the intended slice, including
a. Slice based cell reselection under network control
b. Slice based RACH configuration or access barring

Note: whether the existing mechanism can meet this scenario or requirement can be studied.
2. Study necessity and mechanisms to support service continuity, including a. For intra-RAT handover service interruption, e.g. target gNB doesn't support the UE's ongoing slice, study slice re-mapping, fall-back, and data forwarding procedures. Coordination with SA2 is needed.

### CITATION LIST

### Non Patent Literature

NPL 1: 3GPP TR 21.905: “Vocabulary for 3GPP Specifications”. V15.0.0 (2018-03)

NPL 2: 3GPP TS 23.501: “System Architecture for the 5G System; Stage 2” V16.4.0 (2020-03) http://www.3gpp.org/ftp/Specs/archive/23_series/23.501/23501-g40.zip

NPL 3: 3GPP TS 23.502: “Procedures for the 5G System; Stage 2” V16.4.0 (2020-03) http://www.3gpp.org/ftp/Specs/archive/23_series/23.502/23502-g40.zip

NPL 4: Generic Network Slice Template https://www.gsma.com/newsroom/wp-content/uploads/NG.116-v2.0.pdf

NPL 5: SA2 SID on Enhancement of Network Slicing Phase 2. http://www.3gpp.org/ftp/tsg_sa/WG2_Arch/Latest_SA2_Specs/Latest_draft_S2_S pecs/23700-40-040.zip

NPL 6: 3GPP TS 38.300: “NR; NR and NG-RAN Overall Description; Stage 2”. V16.1.0 (2020-03)

NPL 7: 3GPP TS 38.423: “NG-RAN; Xn application protocol (XnAP)”. V16.1.0 (2020-03)

### SUMMARY OF INVENTION

### Technical Problem

FIG. 1 demonstrates a use case where the UE may not be steered to the best target cell in order to maintain service continuity in connected mode. The following use case is considered:

The UE is registered on the S-NSSAI-1 and the UE is in connected mode, i.e. with active PDU Session(s) on the S-NSSAI-1.

The S-NSSAI-1 is not homogeneously supported in the whole PLMN (as per the current agreements in the 3GPP specifications).

The UE is moving towards the edges of the current registration area into the coverage of the Cell-1 of the TA-1 supporting the S-NSSAI-1 and the Cell-2 of the TA-2 supporting the S-NSSAI-2.

Both cells, the Cell-1 and the Cell-2 are eligible for target cell in a handover.

One of the problems for this disclosure is how to steer the UE in connected mode (e.g. handover) to the Cell-1 (not the Cell-2) so that the service continuity is supported on the S-NSSAI-1. Also, one of the problems for this disclosure is, if there is no target cell to support all the active PDU Session of the UE, then how to select a target cell that supports the PDU Sessions that are of higher importance for the user.

### Solution to Problem

In a first aspect, there is provided an access network node, comprising:

means for communicating with a user equipment, UE, via multiple Protocol Data Unit, PDU, sessions; and

means for selecting another access network node for transferring at least one of the multiple PDU sessions while maintaining a service on the at least one of the multiple PDU sessions, based on at least one of:

network slices on which the multiple PDU sessions are established,

network slices which are supported by at least one cell operated by the another access network node,

user activity of the UE in the at least one of the multiple PDU sessions,

priority among network slices on which the multiple PDU sessions are established,

priority among the multiple PDU sessions,

priority among at least one active PDU session of the multiple PDU sessions,

priority among at least one PDU session which is supported by the at least one cell operated by the another access network node, and

user consent information received from the UE.

In a second aspect, there is provided a user equipment, UE, comprising:

means for communicating with an access network node, via multiple Protocol Data Unit, PDU, sessions; and

means for sending, to the access network node, at least one of:

user consent information; and

priority among the multiple PDU sessions, wherein another access network node for transferring at least one of the multiple PDU sessions is selected by the access network node while maintaining a service on the at least one of the multiple PDU sessions, based on the at least one of the user consent information and the priority among the multiple PDU sessions.

In a third aspect, there is provided a network function node, comprising:

means for receiving, from a user equipment, UE, at least one of a Protocol Data Unit, PDU, session establishment request and a Service Request, including network slice information indicating network slices and multiple PDU session identifiers, IDs indicating multiple PDU sessions;

means for retrieving priority among the network slices, from a network function node for unified data;

means for mapping priority among the PDU sessions and the priority among the network slices; and

means for sending the priority among the PDU sessions to the access network node, wherein

at least one of the priority among the PDU sessions and the priority among the network slices is used for transferring at least one of the multiple PDU sessions while maintaining a service on the at least one of the multiple PDU sessions.

In a fourth aspect, there is provided a control method for an access network node, comprising:

communicating with a user equipment, UE, via multiple Protocol Data Unit, PDU, sessions; and

selecting another access network node for transferring at least one of the multiple PDU sessions while maintaining a service on the at least one of the multiple PDU sessions, based on at least one of:

network slices on which the multiple PDU sessions are established,

network slices which are supported by at least one cell operated by the another access network node,

user activity of the UE in the at least one of the multiple PDU sessions,

priority among network slices on which the multiple PDU sessions are established,

priority among the multiple PDU sessions,

priority among at least one active PDU session of the multiple PDU sessions,

priority among at least one PDU session which is supported by the at least one cell operated by the another access network node, and

user consent information received from the UE.

In a fifth aspect, there is provided a control method for a user equipment, UE, comprising:

communicating with an access network node, via multiple Protocol Data Unit, PDU, sessions; and

sending, to the access network node, at least one of:

user consent information; and

priority among the multiple PDU sessions, wherein

another access network node for transferring at least one of the multiple PDU sessions is selected by the access network node while maintaining a service on the at least one of the multiple PDU sessions, based on the at least one of the user consent information and the priority among the multiple PDU sessions.

In a sixth aspect, there is provided a control method for a network function node, comprising:

receiving, from a user equipment, UE, at least one of a Protocol Data Unit,

PDU, session establishment request and a Service Request, including network slice information indicating network slices and multiple PDU session identifiers, IDs indicating multiple PDU sessions;

retrieving priority among the network slices, from a network function node for unified data;

mapping priority among the PDU sessions and the priority among the network slices; and

sending the priority among the PDU sessions to the access network node, wherein

at least one of the priority among the PDU sessions and the priority among the network slices is used for transferring at least one of the multiple PDU sessions while maintaining a service on the at least one of the multiple PDU sessions.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 demonstrates a use case where the UE may not be steered to the best target cell in order to maintain service continuity in connected mode.

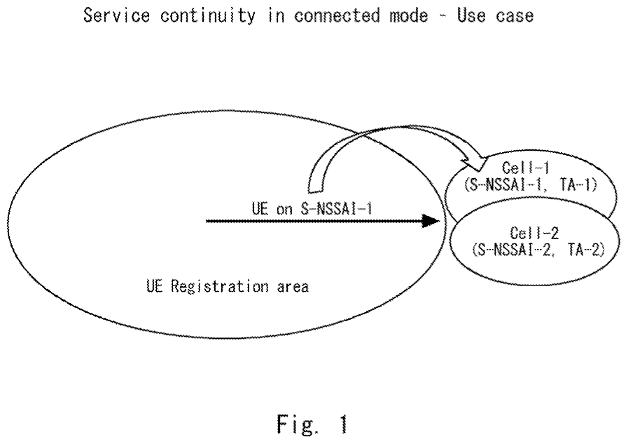

FIG. 2 is a timing (signalling) diagram illustrating schematically an exemplary method for Xn and N2 handover based on the network slice support by the source RAN node and the target RAN node.

FIG. 3 is a timing (signalling) diagram illustrating schematically an exemplary method for service continuity across network slices based on the priority of the UE subscribed network slices.

FIG. 4 is a timing (signalling) diagram illustrating schematically an exemplary method for service continuity across network slices based on the PDU Session priority provided by the UE over the RRC signalling.

FIG. 5 is a timing (signalling) diagram illustrating schematically an exemplary method for service continuity across network slices based on the PDU Session priority provided by the UE over the NAS message.

FIG. 6 is a timing (signalling) diagram illustrating schematically an exemplary method for service continuity across network slices based on PDU Session priority provided by the UE over the NAS message.

FIG. 7 is a timing (signalling) diagram illustrating schematically an exemplary method for service continuity across network slices based on the user consent enquiry over the RRC signalling.

FIG. 8 is a timing (signalling) diagram illustrating schematically an exemplary method for service continuity across network slices based on user consent enquiry over the NAS signalling.

FIG. 9 schematically illustrates a mobile (cellular or wireless) telecommunication system 1 to which the above aspects are applicable.

FIG. 10 is a block diagram illustrating the main components of the UE (mobile device 3)

FIG. 11 is a block diagram illustrating the main components of an exemplary (R)AN node 5.

FIG. 12 is a block diagram illustrating the main components of a generic core network node.

### DESCRIPTION OF EMBODIMENTS

Solution 1—Service continuity across network slices based network slice support of the source and the target cells in handover.

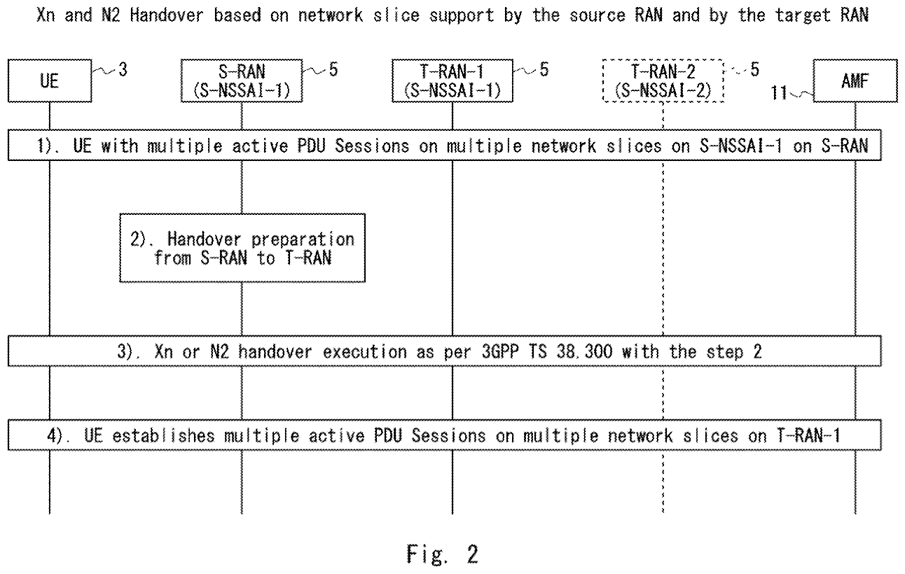

This solution proposes improvements to service continuity across network slices in connected mode mobility (e.g. handover, cell change order or RRC connection release with re-direction). FIG. 2 is a timing (signalling) diagram illustrating schematically an exemplary method for Xn and N2 handover based on the network slice support by the source RAN (S-RAN) node 5, e.g. gNB, NG-RAN node and the target RAN (T-RAN) node 5, e.g. gNB, NG-RAN node.

1) The UE 3 is in connected mode with multiple active PDU Sessions on network slice S-NSSAI-1 on the source RAN (S-RAN).

2) Handover preparation from the source RAN (S-RAN) to the target RAN (T-RAN). If the source RAN node 5 has multiple candidates as a target cell for handover, the source RAN node 5 chooses a target cell taking into account the S-NSSAI(s) on which there are active PDU Sessions in the source RAN node 5, the S-NSSAI(s) supported by the target cells; and the user activity in each PDU session in order to maintain the service continuity on the active PDU Session(s). If still there are PDU Session(s) for which the service continuity cannot be maintained, the source RAN node 5 may choose a target cell based on operator policy or configuration in the source RAN node 5.

Note that the source RAN node 5 obtains information about the network slice support by the target candidate cells during the Xn Setup procedure as described in 3GPP TS 38.423 [NPL 7].

If the target cells are CAG, Closed Access Group, cells and the UE 3 is CAG capable UE (as indicated by the UE network capability information), then when selecting a target cell for handover the RAN node 5 shall also consider the CAG(s) supported by the target cells and the UE's CAG membership or subscription.

3) Xn or N2 handover execution as per 3GPP TS 38.300 [NPL 6] with the Handover preparation as described in step 2 takes into consideration. As the handover preparation in step 2 considers all the aspect of the network slices in the source and target RAN node 5s including the operator's policy and configuration, the UE 3 is steered to a target RAN (T-RAN-1) node 5 which supports the network slice S-NSSAI-1 and which is also supported in the source RAN and on which source RAN has active PDU Sessions. This way the handover to T-RAN-1 allows the best service continuity, i.e. with no PDU Sessions drop.

4) The UE 3 establishes multiple active PDU Sessions on multiple network slices on the target RAN (e.g. T-RAN-1).

Solution 2—Service continuity across network slices based on priority

Use case #2a: Service continuity based on the subscribed network slices priority

It is proposed that the network slices in the network (e.g. in the UDM/UDR 12) that the UE 3 is subscribed to are assigned a priority so that there is a relative priority between the UE subscribed network slices in the network. Each network slice in the UE subscription may have a priority attribute to it, for example—high, medium, low or any other notation or definition for priority that creates relative priority between the UE subscribed network slices.

In addition, if the UE 3 has a subscription to the CAG, it is also proposed that the allowed CAG in the network (e.g. in the UDM/UDR 12) that the UE 3 is subscribed to are assigned a priority so that there is a relative priority between the allowed CAGs in the network. Each allowed CAG in the UE subscription may have a priority attribute to it, for example—high, medium, low or any other notation or definition for priority that creates relative priority between the allowed CAGs.

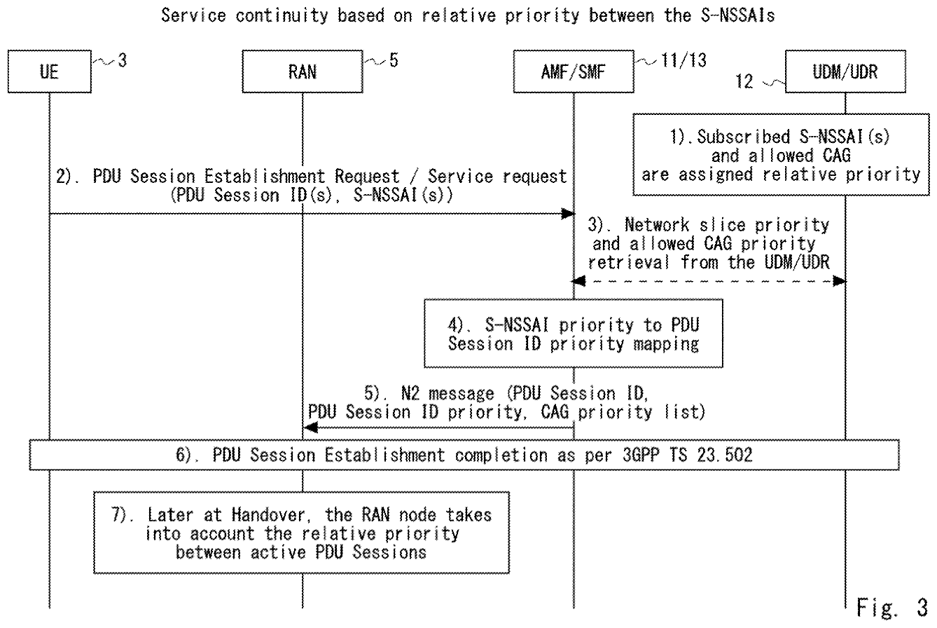

FIG. 3 is a timing (signalling) diagram illustrating schematically an exemplary method for service continuity across network slices based on the priority of the UE subscribed network slices.

1). The UE subscribed network slices are assigned a priority which can be a subscription based priority within the UDM/UDR 12 or configuration based priority or operator's policy based priority. In the case of the subscription based priority, the network slice priority attribute can be assigned:

by the network operator. In this case the network operator assigns a priority attribute (e.g. high, medium, low or any other notation or definition for priority that creates relative priority between the UE subscribed network slices) to the UE subscribed network slices in the UDM/UDR 12 based on contract agreements with the user for example.

by the Service Provider as defined in 3GPP TS 23.502 [NPL 2]. In this case the Service Provider (e.g. AF) may assign a priority attribute (e.g. high, medium, low or any other notation or definition for priority that creates relative priority between the UE subscribed network slices) to the UE subscribed network slices in the UDM/UDR 12 via the Nnef_ParameterProvision service which is used for allowing external party to provision of information which can be used for the UE 3 in 5GS. The Service provider may also use the Nnef_ParameterProvision service to modify (i.e. change up or down) the UE subscribed network slice priority attribute.

2). The UE 3 initiates a service by sending a PDU Session Establishment Request or a Service Request including S-NSSAI(s) and PDU Session ID(s) to the network.

3). During the PDU Session Establishment procedure or Service Request procedure, the AMF 11 or the SMF 13 retrieves the UE subscribed network slices along with their priority attributes unless the AMF 11 or the SMF 13 has the network slice priority attributes in advance.

The AMF 11 may obtain the network slice priority attributes per subscribed S-NSSAI via the Nudm_SDM_Get service during the Registration procedure, i.e. the output of the Nudm_SDM_Get service will have a priority attributes per subscribed S-NSSAI. The UDM/UDR 12 may provide a priority attributes per subscribed S-NSSAI to the AMF 11 only if there is an input parameter in the Nudm_SDM_Get service that indicates a support for the network slices priority handling feature.

The AMF 11 may also obtain the network slice priority attributes for the subscribed S-NSSAIs via the Nudm_SDM_Notification service during the Subscriber Data Update Notification to the AMF 11 procedure, i.e. the input of the Nudm_SDM_Notification service will have a priority attributes per subscribed S-NSSAI. The UDM/UDR 12 may provide a priority attributes per subscribed S-NSSAI to the AMF 11 only if there is an input parameter in the Nudm_SDM_Get service invoked in advance which indicates a support for the network slices priority handling feature.

The SMF 13 may obtain the network slice priority attributes per subscribed S-NSSAI via the Nudm_SDM_Get service during the PDU Session Establishment or Service Request procedure, i.e. the output of Nudm_SDM_Get service will have a priority attributes per subscribed S-NSSAI.

The SMF 13 may obtain the network slice priority attributes by the Nudm_SDM_Notification service during the Session Management Subscriber Data Update Notification to SMF 13 procedure, i.e. the input of Nudm_SDM_Notification service will have a priority attributes per subscribed S-NSSAI.

In addition, during the PDU Session Establishment procedure or Service Request procedure, the AMF 11 or the SMF 13 retrieves the allowed CAG(s) along with their priority attributes unless the AMF 11 or the SMF 13 has the allowed CAG(s) attributes in advance.

The AMF 11 may obtain the CAG priority attributes per allowed CAG via the Nudm_SDM_Get service during the Registration procedure, i.e. the output of the Nudm_SDM_Get service will have a priority attributes per allowed CAG. The UDM/UDR 12 may provide a priority attributes per allowed CAG to the AMF 11 only if there is an input parameter in the Nudm_SDM_Get service that indicates a support for the CAG priority handling feature.

The AMF 11 may also obtain the CAG priority attributes for the allowed CAG via the Nudm_SDM_Notification service during the Subscriber Data Update Notification to the AMF 11 procedure, i.e. the input of the Nudm_SDM_Notification service will have a priority attributes per allowed CAG. The UDM/UDR 12 may provide a priority attributes per allowed CAG to the AMF 11 only if there is an input parameter in the Nudm_SDM_Get service invoked in advance which indicates a support for the allowed CAG priority handling feature.

The SMF 13 may obtain the CAG priority attributes per allowed CAG via the Nudm_SDM_Get service during the PDU Session Establishment or Service Request procedure, i.e. the output of Nudm_SDM_Get service will have a priority attributes per allowed CAG.

The SMF 13 may obtain the CAG priority attributes by the Nudm_SDM_Notification service during the Session Management Subscriber Data Update Notification to SMF 13 procedure, i.e. the input of Nudm_SDM_Notification service will have a priority attributes per allowed CAG.

4). The AMF 11 or the SMF 13 maps the priority of the network slice (e.g. the S-NSSAI) on which the UE 3 has initiated PDU Session Establishment or Service Request with the PDU Session ID. In this way the PDU Session takes the priority of the network slice on which it is being established.

The PDU Session ID priority may be set based on the local policy in the VPLMN even if there is a mapped priority based on the subscribed S-NSSAI. If the AMF 11 or the SMF 13 has not received any priority for the network slice from the UDM/UDR 12 (for example, due to lack of support of network slice priority handling in the UDM), The AMF 11 or the SMF 13 may set the PDU Session ID priority based on the local operator policy or configuration including the following logics:

If the UE 3 is categorized as a voice centric UE 3 as per the definition in 3GPP TS 23.501 [NPL 2], the AMF 11 or the SMF 13 assigns a relatively high priority to a PDU Session that is associated with an S-NSSAI for the IMS service.

If the UE 3 is categorized as a data centric UE 3 as per the definition in 3GPP TS 23.501 [NPL 2], the AMF 11 or the SMF 13 assigns a relatively low priority to a PDU Session that is associated with an S-NSSAI for the IMS service.

If the UE 3 has IoT service attributes, the AMF 11 or the SMF 13 assigns a relatively high priority to a PDU Session that is associated to an S-NSSAI with the IoT service.

If the AMF 11 or the SMF 13 has received the CAG priority attributes per allowed CAG from the UDM/UDR 12, then the AMF 11 constructs new N2 parameter CAG priority list. The CAG priority list includes a priority among the non-CAG and other CAG(s).

5). The AMF 11 or the SMF 13 indicates the PDU Session ID and the PDU Session ID priority and CAG priority list to the RAN node 5 via a N2 message. The PDU Session ID and PDU Session ID priority parameters may be delivered to the RAN node 5 directly as parameters of the N2 message or within the Core Network Assistance parameter.

6).The PDU Session Establishment is completed as per 3GPP TS 23.502 [NPL 3]. This way, in a case where the UE 3 establishes multiple PDU Sessions on multiple network slices, each active PDU Session will have a priority relatively comparable with the priority of the rest of the active PDU Sessions.

7). Later, at connected mode mobility (e.g. handover), when selecting a target cell to which to steer the UE 3, the RAN node 5 may consider the relative priority of the active PDU Sessions so that the RAN node 5 gives priority to a target cell that allows service continuity for the PDU Sessions with the highest relative priority, i.e. the RAN node 5 selects a target cell that supports a network slice on which the highest priority PDU Sessions are associated with.

If the target cells are CAG cells and the UE 3 is CAG capable UE 3 (as indicated by the UE 3 network capability information), then when selecting a target cell for handover the RAN node 5 shall also consider the CAG(s) supported by the target cells and the UE 3's CAG membership or subscription based on the received CAG priority list from the AMF 11 or SMF 13.

Use case #2b: Service continuity based on the PDU Session priority provided by the UE 3 over the AS

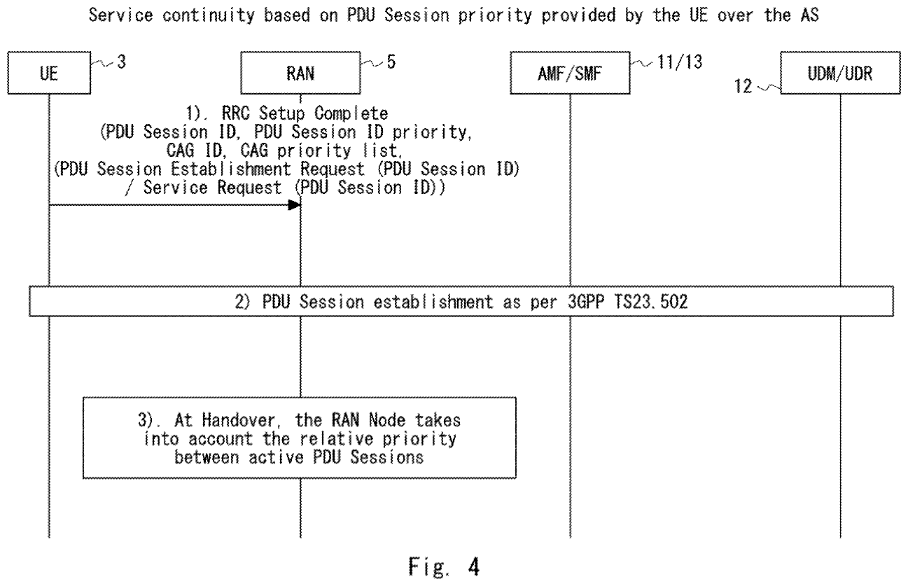

It is proposed that when the UE 3 triggers a request for service via a PDU Session Establishment Request message or a Service Request message, the UE 3 provides both a PDU session ID and an associated priority for the PDU Session via the RRC signalling. FIG. 4 is a timing (signalling) diagram illustrating schematically an exemplary method for service continuity across network slices based on the PDU Session priority provided by the UE 3 over the RRC signalling.

1). The UE 3 initiates a service by sending PDU Session Establishment Request message or Service Request message to the network embedded in the RRC message (e.g. RRC Connection Setup Complete message). In the RRC message (e.g. RRC Setup Complete message), the UE 3 includes both, the PDU session ID and the associated PDU Session ID priority parameter (e.g. high, medium, low or any other notation to assign a priority to the PDU Session that is to be established). The RAN node 5 stores both the PDU session ID and the associated PDU Session ID priority for the duration of the PDU Session in the RAN node 5. If there are multiple PDU Sessions to be established using one RRC signaling connection, the RRC signaling might convey a list of PDU Session IDs and the associated priority.

In addition, the RRC message (e.g. RRC Setup Complete message) may include both CAG ID and the CAG priority list. The CAG ID is the CAG Identifier that the UE 3 is accessing with. The CAG priority list includes a priority among the non-CAG and other CAG(s).

The UE 3 also maintains the PDU Session ID and the associated PDU Session ID priority for the duration of the PDU Session. The UE 3 can update the associated PDU Session ID priority anytime for the duration of the PDU Session. For example, when the UE 3 adds new PDU Sessions, the UE 3 may include all PDU Session IDs and associated PDU Session ID priority in the RRC signaling message so that relative priorities among PDU Sessions can be renewed.

2). The PDU Session Establishment procedure continues as per 3GPP TS 23.502. When the UE 3 establishes multiple PDU Sessions on multiple network slices, each active PDU Session will have a priority relatively comparable with the priority of the rest of the active PDU Sessions within the RAN Node. 3). Later, at connected mode mobility (e.g. handover), when selecting a target cell to which to steer the UE 3, the RAN node 5 may consider the relative priority of the active PDU Sessions so that the RAN node 5 gives priority to a target cell that allows service continuity for the PDU Sessions with the highest relative priority, i.e. the RAN node 5 selects a target cell that supports a network slice on which the highest priority PDU Session(s) are active. Also, at handover, the RAN node 5 passes the list of active PDU Sessions and their priority to the target RAN node 5 so that the target RAN node 5 can also consider the relative PDU Session priority of the active PDU Sessions when selecting a target cell for the next handover.

If the target cells are CAG cells and the UE 3 is CAG capable UE 3 (as indicated by the UE 3 network capability information), then when selecting a target cell for handover the RAN node 5 shall also consider the CAG(s) supported by the target cells and the UE 3's CAG membership or subscription.

Use case #2c: Service continuity based on PDU Session priority provided by the UE 3 over the NAS

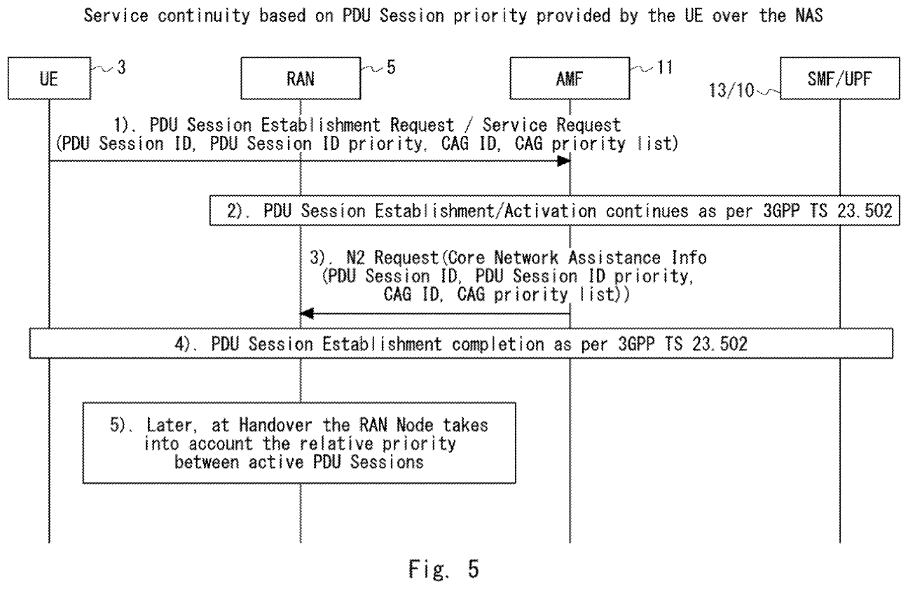

It is proposed that when the UE 3 triggers a request for service via a PDU Session Establishment Request message or a Service Request message, the user may choose to prioritize the service and if so, the UE 3 provides priority for the PDU Session over the NAS (e.g. within the PDU Session Establishment Request message or Service Request message).The PDU Session priority may also be based on user preferences set in the UE 3 in advance by prioritizing the type of the service (e.g. based on the network slice priority). FIG. 5 is a timing (signalling) diagram illustrating schematically an exemplary method for service continuity across network slices based on the PDU Session priority provided by the UE 3 over the NAS message.

1). The UE 3 initiates a service by sending a PDU Session Establishment Request message or a Service Request message to the network. In the PDU Session Establishment Request message or in the Service Request message, the UE 3 includes a PDU Session priority parameter (e.g. PDU Session ID priority=high, medium, low or any other notation to indicate the priority level of the PDU Session that is being established) along with the PDU Session ID. The AMF 11 or the SMF 13 stores the PDU Session ID and the PDU Session ID priority.

In addition, the PDU Session Establishment Request message or the Service Request message may include CAG ID and the CAG priority list. The CAG ID is the CAG Identifier that the UE 3 is accessing with. The CAG priority list includes a priority among the non-CAG and other CAG(s).

2). PDU Session Establishment continues as per 3GPP TS 23.502 [NPL 3].

3). The AMF 11 may indicate to the RAN node 5 in the N2 Request message within the Core Network Assistance Information parameter or as separate parameters the PDU Session ID and its priority, e.g. PDU Session ID priority. The RAN node 5 stores the information about the activated PDU Sessions and their priority, e.g. PDU Session ID and PDU Session ID priority.

When the UE 3 establishes multiple PDU Sessions on multiple network slices, each active PDU Session will have a priority relatively comparable with the priority of the rest of the active PDU Sessions within the RAN node 5.

If the AMF 11 or the SMF 13 has received the CAG ID and the CAG priority list from the UE 3 in step 1, the CAG ID and the CAG priority list are also included in the N2 Request message.

4) PDU Session Establishment completion as per 3GPP TS 23.502 [NPL 3].

5). Later, at connected mode mobility (e.g. handover), when selecting a target cell to which to steer the UE 3, the RAN node 5 may consider the relative priority of the active PDU Sessions so that the RAN node 5 gives priority to a target cell that allows service continuity for the PDU Session(s) with the highest relative priority, i.e. the RAN node 5 selects a target cell that supports a network slice on which the highest priority PDU Session(s) are active. Also, at handover, the RAN node 5 passes the list of active PDU Sessions and their priority to the target RAN node 5 so that the target RAN node 5 can also consider the relative PDU Sessions priority when selecting a target cell for handover.

If the target cells are CAG cells and the UE 3 is CAG capable UE 3 (as indicated by the UE 3 network capability information), then when selecting a target cell for handover the RAN node 5 shall also consider the CAG(s) supported by the target cells and the UE 3's CAG membership or subscription.

Use case #2d: Service continuity based on the network slice priority provided by the UE 3 over the NAS

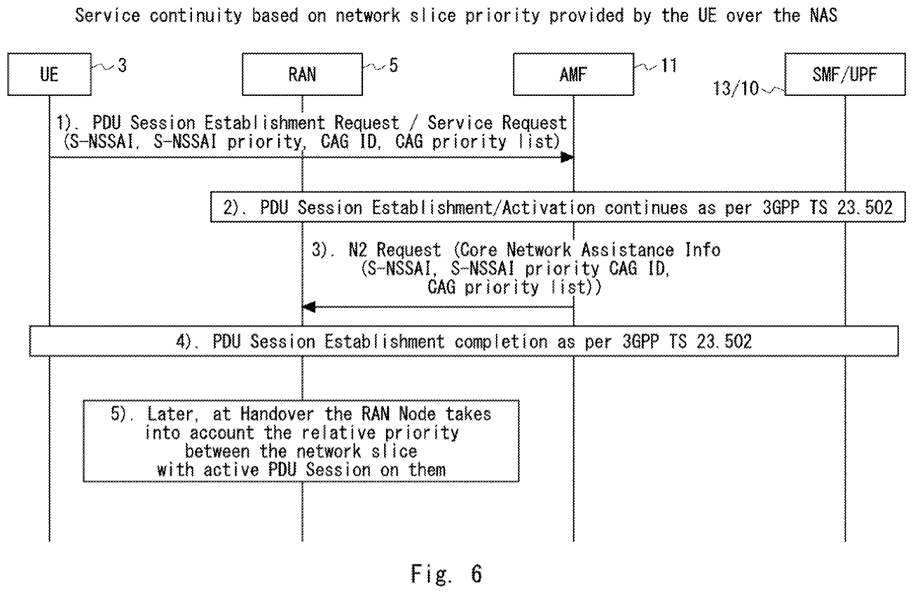

It is proposed that a user may decide to prioritize specific services. This could be done by setting user preferences based on the type of the service, e.g. based on the network slice which provides these services. In this way, the user can create relative priority between the network slices the UE 3 is allowed to access. When the UE 3 triggers a request for service via a PDU Session Establishment Request message or a Service Request message, the UE 3 provides priority for the network slice over the NAS (e.g. within the PDU Session Establishment Request message or Service Request message). FIG. 6 is a timing (signalling) diagram illustrating schematically an exemplary method for service continuity across network slices based on PDU Session priority provided by the UE 3 over the NAS message.

1). The UE 3 initiates a service by sending a PDU Session Establishment Request message or a Service Request message to the network. In the PDU Session Establishment Request message or in the Service Request message, the UE 3 includes network slice priority parameter (e.g. S-NSSAI priority=high, medium, low or any other notation to indicate the priority level of the network slice on which the PDU Session is being established) along with the network slice identity itself (i.e. the S-NSSAI). The AMF 11 or the SMF 13 stores the network slice identity (S-NSSAI) and the network slice priority (S-NSSAI priority).

In addition, the PDU Session Establishment Request message or a Service Request message may include CAG ID and the CAG priority list. The CAG ID is the CAG Identifier that the UE 3 is accessing with. The CAG priority list includes a priority among the non-CAG and other CAG(s).

2). PDU Session Establishment continues as per 3GPP TS 23.502 [NPL 3].

3). The AMF 11 may indicate to the RAN node 5 in the N2 Request message within the Core Network Assistance Information parameter or as a separate parameters the S-NSSAI and its priority, e.g. S-NSSAI priority. The RAN node 5 stores the information about the network slice on which a PDU Session is activated and the priority of the network slice, i.e. the S-NSSAI and S-NSSAI priority.

When the UE 3 establishes multiple PDU Sessions on multiple network slices, each network slice on which a PDU Session is established will have a priority relatively comparable with the priority of the other network slices with established PDU Sessions on them.

If the AMF 11 or the SMF 13 has received the CAG ID and the CAG priority list from the UE 3 in step 1, CAG ID and CAG priority list are also included in the N2 Request message.

4). PDU Session Establishment completion as per 3GPP TS 23.502 [NPL 3].

5). Later, at connected mode mobility (e.g. handover), when selecting a target cell to which to steer the UE 3, the RAN node 5 may consider the relative priority of the network slices with active PDU Session(s) so that the RAN node 5 gives a priority to a target cell that allows service continuity for the PDU Sessions which are on network slices with higher priority, i.e. the RAN node 5 selects a target cell based on the relative priority of the network slices with active PDU session on them. Also, at handover, the RAN node 5 passes the list of network slices with active PDU Sessions on them along with the priority of these network slices to the target RAN node 5 so that the target RAN node 5 can also consider the relative network slice priority when selecting a target cell for handover.

If the target cells are CAG cells and the UE 3 is CAG capable UE 3 (as indicated by the UE 3 network capability information), then when selecting a target cell for handover the RAN node 5 shall also consider the CAG(s) supported by the target cells and the UE 3's CAG membership or subscription.

Solution 6—Service continuity across network slices based on user consent Use case #3a: User consent via AS

This use case proposes user consent assistance for the service continuity via a

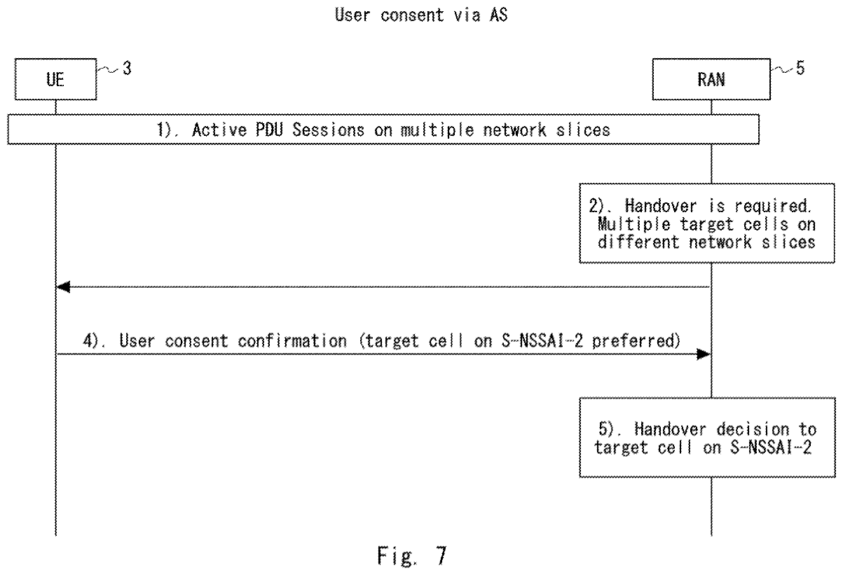

RRC signalling. FIG. 7 is a timing (signalling) diagram illustrating schematically an exemplary method for service continuity across network slices based on the user consent enquiry over the RRC signalling.

1) The UE 3 is in connected mode with multiple active PDU Sessions over multiple network slices.

2) Handover is required. Multiple target cells are suitable for handover however, none of them supports all the network slices with active PDU Session(s) on them, i.e. there is no target cell that can support all the active PDU Sessions and some of them shall be dropped.

3) In order to decide which PDU sessions to maintain, the RAN node 5 may trigger a user consent enquiry procedure which can be a new designated procedure for user consent enquiry or the RAN node 5 may make use of the existing RRC messages in order to request the user consent. In the user consent enquiry message to the UE 3 the RAN node 5 includes parameters representing the possible choices the user can make in terms of which services can be retained or which services shall be dropped at handover. For example, to allow the user to select between a target cell on network slice S-NSSAI-1 and a target cell on network slice S-NSSAI-2, the RAN node 5 may indicate to the UE 3 the network slices of the target cells S-NSSAI-1 and S-NSSAI-2 within the user consent request message and then the UE 3 may present S-NSSAI-1 and S-NSSAI-2 to the user in the form of services supported by these two network slices, e.g. voice and internet so that the user may make easy and informed choice for his preferred service to be maintained.

4) If the user makes a choice, the UE 3 returns the user's choice within the user consent confirmation message to the RAN node 5 or within any one of the existing RRC messages. If the user does not wish to make a choice or the time for making a choice expires, the UE 3 returns a default value (e.g. no choice value) within the user consent confirmation message or within any one of the existing RRC messages.

As user consent by human takes time and may cause negative effect to handover performance, one implementation could be that the user consent can be made by preconfigured logic in the UE 3. The list below shows examples of preconfigured logic.

If the User has an active voice call or video call ongoing, then an S-NSSAI that are associated with the IMS service can take precedence over any other S-NSSAI.

If the UE 3 moves to a pre-configured location for example the factory where URLLC is available, then an S-NSSAI that are associated with the URLLC service can take precedence over any other S-NSSAI.

5) When selecting the target cell for handover, the RAN node 5 considers the user consent received from the UE 3, if available.

Use case #3b: User consent via NAS

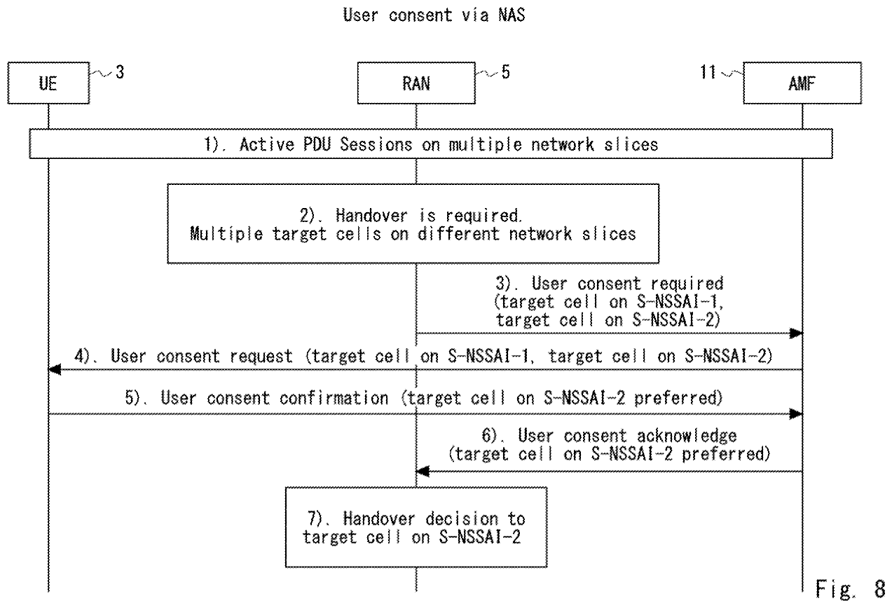

This use case proposes user consent assistance for service continuity via a NAS signalling. FIG. 8 is a timing (signalling) diagram illustrating schematically an exemplary method for service continuity across network slices based on user consent enquiry over the NAS signalling.

1) The UE 3 is in connected mode with multiple active PDU Sessions over multiple network slices.

2) Handover is required. Multiple target cells are suitable for handover however, none of them supports all the network slice with active PDU Session on them, i.e. there is no target cell that can support all the active PDU Sessions and some of them shall be dropped.

3) In order to decide which PDU sessions to maintain, the RAN node 5 may trigger user consent enquiry procedure. The RAN node 5 sends the user consent required message to the AMF 11 in which the RAN node 5 includes parameters representing the possible choices the user can make in terms of which services to be retained or which services shall be dropped at handover. The RAN node 5 may indicate to the AMF 11 the network slices of the target cells S-NSSAI-1 and S-NSSAI-2 within the user consent request message.

4) The AMF 11 sends user consent request message to the UE 3 in which the AMF 11 includes the user consent parameters, i.e. the possible user choices with regards to which service to preserve or which service to drop that the AMF 11 received from the RAN node 5. For example, to allow the user to select between a target cell on network slice S-NSSAI-1 and a target cell on network slice S-NSSAI-2, the AMF 11 node may indicate to the UE 3 the network slices of the target cells S-NSSAI-1 and S-NSSAI-2 within the user consent request message and then the UE 3 may present S-NSSAI-1 and S-NSSAI-2 to the user in the form of services supported by these two network slices, e.g. voice and internet so that the user may make easy and informed choice for his preferred service to be Alternatively, the AMF 11 may use one of the existing NAS messages for user consent request from the UE 3.

5) If the user makes a choice, the UE 3 returns the user's choice within the user consent confirmation message or within any one of the existing NAS messages to the AMF 11. If the user does not wish to make a choice or the time for making a choice expires, the UE 3 returns a default value (e.g. no choice value) within the user consent confirmation message or within any one of the existing NAS messages.

As user consent by human takes time and may cause negative effect to handover performance, one implementation could be that the user consent can be made by preconfigured logic in the UE 3. The list below shows examples of preconfigured logic.

If the User has an active voice call or video call ongoing, then an S-NSSAI that are associated with the IMS service can take precedence over any other S-NSSAI.

If the UE 3 moves to a pre-configured location for example the factory where URLLC is available, then an S-NSSAI that are associated with the URLLC service can take precedence over any other S-NSSAI.

6) The AMF 11 acknowledges the user consent received by the UE 3 to the RAN node 5. The acknowledgement from the AMF 11 may include information for indicating the user's choice.

7) When selecting the target cell for handover, the RAN node 5 considers the user consent, if available.

### SUMMARY

Beneficially, the above described aspects include, although they are not limited to, one or more of the following functionalities:

Network slices and CAG support by both the source cell and target cell consideration for improved service continuity. [solution 1]

Relative priority for UE 3 subscribed S-NSSAI and CAG(s) in the UDM. [solution 2a]

Relative priority for the active PDU sessions based on user decision or preferences in direct UE 3 to RAN interaction. [solution 2b]

Relative priority for PDU Sessions (per PDU Session priority) based on user decision or preferences in UE 3 to RAN interaction via the AMF 11 [solution 2c]

Relative priority for PDU Sessions on a specific network slice (per slice priority) based on user decision or preferences [solution 2d]

New procedure for user consent retrieval from the UE 3. [solution 3]In order to provide these functionalities, the above aspects describe exemplary methods comprising (at least some of) the following steps:

Network control for improved service continuity in connected mode based on the UE 3 subscribed S-NSSAIs and CAGs relative priority [solution 2a]

UE 3 control for improved service continuity in connected mode based on PDU Sessions relative priority set by the user. [solution 2b]

Core Network assistance based on the user defined PDU Session priority for improved service continuity in connected mode. [solution 2c]

Core Network assistance based on the user defined network slice and CAG priority for improved service continuity in connected mode. [solution 2d]

Steering the UE 3 to a target cell based on the user consent so that user preferred service is maintained in connected mode mobility when not all active services are supported in the target cells. [solution 3]

### <Benefits>

The present disclosure proposes various methods for service continuity for mobile terminals in connected mode. These methods allow for a prioritized service continuity based on user preferences. Thus the services of importance to the user have better chance for service continuity when not all of the active services can be maintained.

### <System Overview>

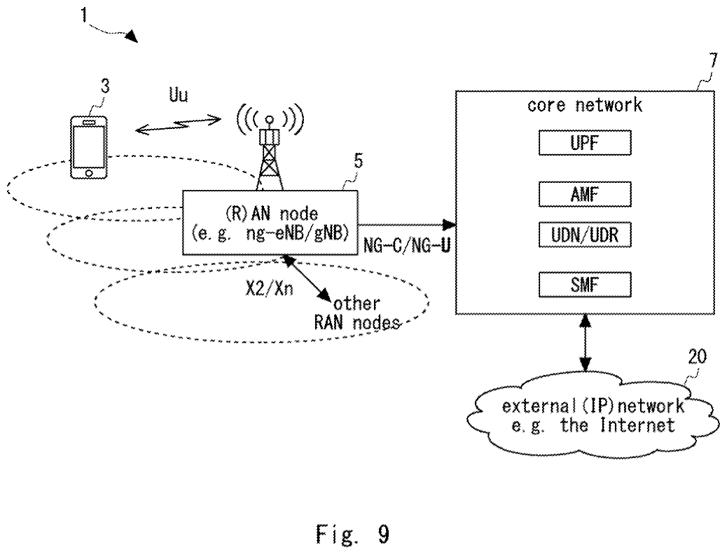

FIG. 9 schematically illustrates a mobile (cellular or wireless) telecommunication system 1 to which the above aspects are applicable.

In this network, users of mobile devices 3 (UE 3s) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 (RAN) are shown in FIG. 9 for illustration purposes, the system, when implemented, will typically include other base stations and mobile devices (UE 3s).

Each base station 5 controls one or more associated cells (either directly or via other nodes such as home base stations, relays, remote radio heads, distributed units, and/or the like). A base station 5 that supports E-UTRA/4G protocols may be referred to as an ‘eNB’ and a base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N2’, ‘N3’ interface, and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs) 10. It will be appreciated that the core network 7 may also include, amongst others: an Access and Mobility Management Function (AMF) 11, a Unified Data Management (UDM)/Unified Data Repository (UDR) function 12, and a Session Management Function (SMF) 13. Although not shown in FIG. 9, the core network 7 may also be coupled to at least one application function (AF)/application server (AS), and/or the like. From the core network 7, connection to an external IP network/data network 20 (such as the Internet) is also provided.

The components of this system 1 are configured to perform one or more of the above described aspects.

### <User Equipment (UE 3)>

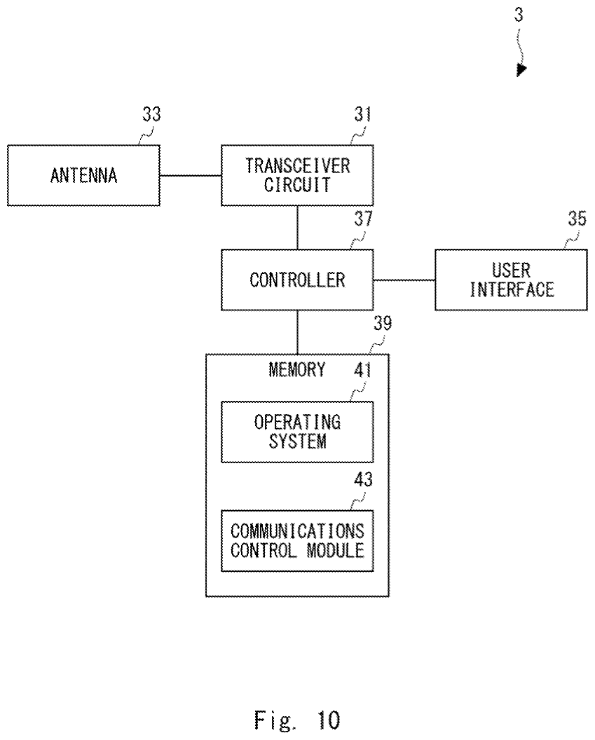

FIG. 10 is a block diagram illustrating the main components of the UE 3 (mobile device 3) shown in FIG. 9. As shown, the UE 3 includes a transceiver circuit 31 which is operable to transmit signals to and to receive signals from the connected node(s) via one or more antenna 33. Although not necessarily shown in FIG. 10, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including (R)AN nodes 5, application functions, and core network nodes. Such signaling includes appropriately formatted requests and responses relating to management of network slices and service continuity.

### <(R)AN Node 5>

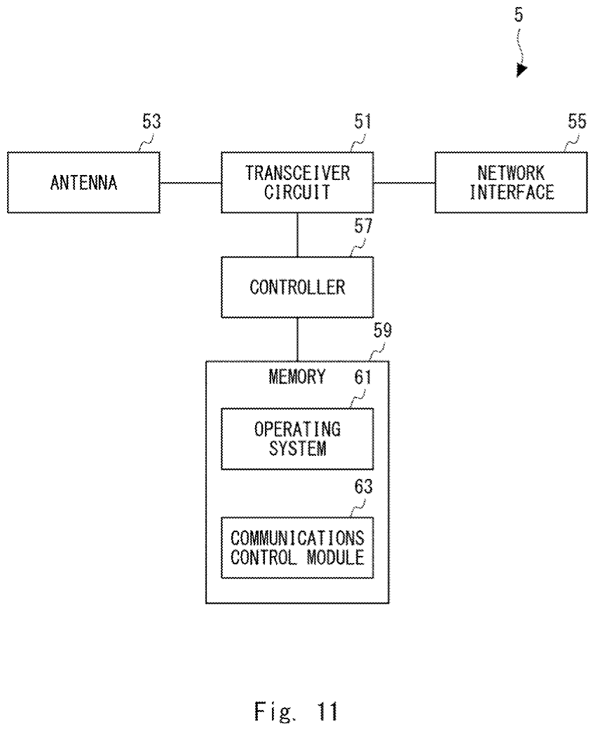

FIG. 11 is a block diagram illustrating the main components of an exemplary (R)AN node 5 (base station) shown in FIG. 9. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N2/N3). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signalling between the (R)AN node 5 and other nodes, such as the UE 3, and the core network nodes. Such signaling includes appropriately formatted requests and responses relating to management of network slices and service continuity.

### <Core Network Node>

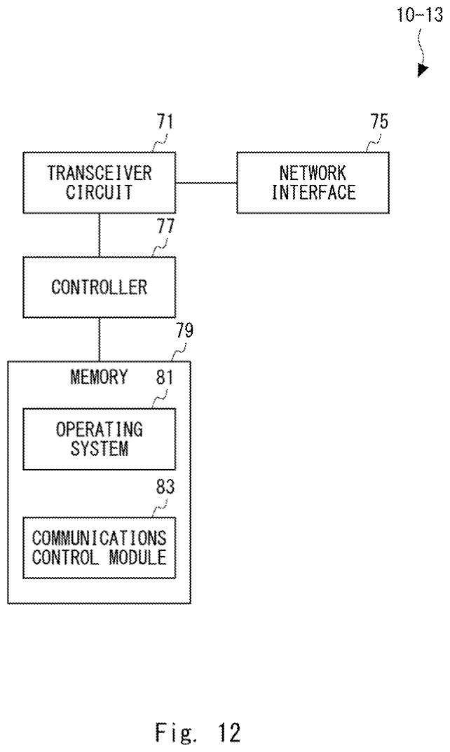

FIG. 12 is a block diagram illustrating the main components of a generic core network node (or function) shown in FIG. 9, for example, the UPF 10, the AMF 11, the UDM/UDR 12, and the SMF 13. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 3, (R)AN node 5, and other core network nodes. Such signaling includes appropriately formatted requests and responses relating to management of network slices and service continuity.

### <Modifications and Alternatives>

Detailed aspects have been described above. As those skilled in the art will appreciate, a number of modifications and alternatives can be made to the above aspects whilst still benefiting from the inventions embodied therein. By way of illustration only a number of these alternatives and modifications will now be described.

In the above description, the UE 3, the (R)AN node 5, and the core network node are described for ease of understanding as having a number of discrete modules (such as the communication control modules). Whilst these modules may be provided in this way for certain applications, for example where an existing system has been modified to implement the above aspects, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3, the (R)AN node 5, and the core network node as a signal over a computer network, or on a recording medium. Further, the functionality performed by part or all of this software may be performed using one or more dedicated hardware circuits. However, the use of software modules is preferred as it facilitates the updating of the UE 3, the (R)AN node 5, and the core network node in order to update their functionalities.

The above aspects are also applicable to ‘non-mobile’ or generally stationary user equipment.

Various other modifications will be apparent to those skilled in the art and will not be described in further detail here.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

Although the present invention has been described with reference to the exemplary embodiments, the present invention is not limited to the above. Various changes that can be understood by those skilled in the art can be made to the configuration and details of the present invention within the scope of the invention.

For example, the whole or part of the exemplary embodiments disclosed above can be described as, but not limited to, the following supplementary notes.
(Supplementary note 1)

An access network node, comprising:

means for communicating with a user equipment, UE, via multiple Protocol Data Unit, PDU, sessions; and

means for selecting another access network node for transferring at least one of the multiple PDU sessions while maintaining a service on the at least one of the multiple PDU sessions, based on at least one of:

network slices on which the multiple PDU sessions are established,

network slices which are supported by at least one cell operated by the another access network node,

user activity of the UE in the at least one of the multiple PDU sessions,

priority among network slices on which the multiple PDU sessions are established,

priority among the multiple PDU sessions,

priority among at least one active PDU session of the multiple PDU sessions,

priority among at least one PDU session which is supported by the at least one cell operated by the another access network node, and

user consent information received from the UE.
(Supplementary note 2)

The access network node according to Supplementary notel, wherein

the means for selecting is configured to select the another access network node based on the network slices which are supported by the at least one cell operated by the another access network node, and the access network node further comprises:

means for receiving the network slices which are supported by the at least one cell operated by the another access network node, from the another access network node on an inter-access network node interface setup procedure.
(Supplementary note 3)

The access network node according to Supplementary note 1, wherein

the means for selecting is configured to select the another access network node based on the priority among the multiple PDU session, and

the priority among the multiple PDU sessions is mapped to each of the multiple PDU sessions.
(Supplementary note 4)

The access network node according to Supplementary note 2, wherein

the priority among the multiple PDU sessions is mapped from at least one of priority among network slices with the multiple PDU session thereon and priority among at least one of closed access groups, CAGs, supported by at least one cell operated by the another access network node.
(Supplementary note 5)

The access network node according to Supplementary note 4, further comprising:

means for receiving the priority among the multiple PDU sessions from the UE, via an access stratum message or a non-access stratum message.
(Supplementary note 6)

The access network node according to Supplementary note 4, wherein

the at least one of the priority among the network slice and the priority among the at least one of CAGs is managed by a network function node for unified data.
(Supplementary note 7)

The access network node according to Supplementary note 4, wherein

the at least one of the priority among the network slice and the priority among the at least one of CAGs is assigned by a network function node for mobility management or a network function node for session management.
(Supplementary note 8)

The access network node according to any one of Supplementary notes 1 to 7, wherein

the transferring is occurred due to at least one of mobility of the UE, a handover, a cell change order, and a Radio Resource Control, RRC, connection release with re-direction.
(Supplementary note 9)

The access network node according to any one of Supplementary notes 1 to 8, wherein

the means for selecting is configured to select the another access network node, based on at least one of closed access groups, CAGs, supported by at least one cell operated by the another access network node and based on the membership or subscription of the UE for the at least one of CAGs.
(Supplementary note 10)

The access network node according to Supplementary note 9, wherein

the means for selecting is configured to select the another access network node, based on priority among the at least one of CAGs.
(Supplementary note 11)

A user equipment, UE, comprising:

means for communicating with an access network node, via multiple Protocol Data Unit, PDU, sessions; and

means for sending, to the access network node, at least one of:

user consent information; and

priority among the multiple PDU sessions, wherein another access network node for transferring at least one of the multiple PDU sessions is selected by the access network node while maintaining a service on the at least one of the multiple PDU sessions, based on the at least one of the user consent information and the priority among the multiple PDU sessions.
(Supplementary note 12)

A network function node, comprising:

means for receiving, from a user equipment, UE, at least one of a Protocol Data Unit, PDU, session establishment request and a Service Request, including network slice information indicating network slices and multiple PDU session identifiers, IDs indicating multiple PDU sessions;

means for retrieving priority among the network slices, from a network function node for unified data;

means for mapping priority among the PDU sessions and the priority among the network slices; and

means for sending the priority among the PDU sessions to the access network node, wherein

at least one of the priority among the PDU sessions and the priority among the network slices is used for transferring at least one of the multiple PDU sessions while maintaining a service on the at least one of the multiple PDU sessions.
(Supplementary note 13)

A control method for an access network node, comprising: communicating with a user equipment, UE, via multiple Protocol Data Unit, PDU, sessions; and

selecting another access network node for transferring at least one of the multiple PDU sessions while maintaining a service on the at least one of the multiple PDU sessions, based on at least one of:

network slices on which the multiple PDU sessions are established,

network slices which are supported by at least one cell operated by the another access network node,

user activity of the UE in the at least one of the multiple PDU sessions,

priority among network slices on which the multiple PDU sessions are established,

priority among the multiple PDU sessions,

priority among at least one active PDU session of the multiple PDU sessions,

priority among at least one PDU session which is supported by the at least one cell operated by the another access network node, and

user consent information received from the UE.
(Supplementary note 14)

The control method according to Supplementary note 13, wherein

the selecting includes selecting the another access network node based on the network slices which are supported by the at least one cell operated by the another access network node, and the control method further comprises:

receiving the network slices which are supported by the at least one cell operated by the another access network node, from the another access network node on an inter-access network node interface setup procedure.
(Supplementary note 15)

The control method according to Supplementary note 13, wherein

the selecting includes selecting the another access network node based on the priority among the multiple PDU session, and

the priority among the multiple PDU sessions is mapped to each of the multiple PDU sessions.
(Supplementary note 16)

The control method according to Supplementary note 14, wherein

the priority among the multiple PDU sessions is mapped from at least one of priority among network slices with the multiple PDU session thereon and priority among at least one of closed access groups, CAGs, supported by at least one cell operated by the another access network node.
(Supplementary note 17)

The control method according to Supplementary note 16, further comprising:

receiving the priority among the multiple PDU sessions from the UE, via an access stratum message or a non-access stratum message.
(Supplementary note 18)

The control method according to Supplementary note 16, wherein

the at least one of the priority among the network slice and the priority among the at least one of CAGs is managed by a network function node for unified data.
(Supplementary note 19)

The control method according to Supplementary note 16, wherein

the at least one of the priority among the network slice and the priority among the at least one of CAGs is assigned by a network function node for mobility management or a network function node for session management.
(Supplementary note 20)

The control method according to any one of Supplementary notes 13 to 19, wherein

the transferring is occurred due to at least one of mobility of the UE, a handover, a cell change order, and a Radio Resource Control, RRC, connection release with re-direction.
(Supplementary note 21)

The control method according to any one of Supplementary notes 13 to 20, wherein

the selecting includes selecting the another access network node, based on at least one of closed access groups, CAGs, supported by at least one cell operated by the another access network node and based on the membership or subscription of the UE for the at least one of CAGs.
(Supplementary note 22)

The control method according to Supplementary note 21, wherein

the selecting includes selecting the another access network node, based on priority among the at least one of CAGs.
(Supplementary note 23)

A control method for a user equipment, UE, comprising:

communicating with an access network node, via multiple Protocol Data Unit, PDU, sessions; and

sending, to the access network node, at least one of:

user consent information; and

priority among the multiple PDU sessions, wherein

another access network node for transferring at least one of the multiple PDU sessions is selected by the access network node while maintaining a service on the at least one of the multiple PDU sessions, based on the at least one of the user consent information and the priority among the multiple PDU sessions.
(Supplementary note 24)

A control method for a network function node, comprising:

receiving, from a user equipment, UE, at least one of a Protocol Data Unit, PDU, session establishment request and a Service Request, including network slice information indicating network slices and multiple PDU session identifiers, IDs indicating multiple PDU sessions;

retrieving priority among the network slices, from a network function node for unified data;

mapping priority among the PDU sessions and the priority among the network slices; and

sending the priority among the PDU sessions to the access network node, wherein

at least one of the priority among the PDU sessions and the priority among the network slices is used for transferring at least one of the multiple PDU sessions while maintaining a service on the at least one of the multiple PDU sessions.

This application is based upon and claims the benefit of priority from European provisional patent application No. EP20186525.0, filed on Jul. 17, 2020, the disclosure of which is incorporated herein in its entirety by reference.

### REFERENCE SIGNS LIST

1 System
3 Mobile device, UE
5 (RA)N node, Base station
7 Core network
10 User plane functions (UPFs)
11 Access and Mobility Management Function (AMF)
12 Unified Data Management (UDM)/Unified Data Repository (UDR) function
13 Session Management Function (SMF)
20 External IP network
31 Transceiver circuit
33 Antenna
37 User interface
39 Controller
39 Memory
41 Operating system
43 Communications control module
51 Transceiver circuit
53 Antenna
55 Network interface
57 Controller
59 Memory
61 Operating system
63 Communications control module
71 Transceiver circuit
75 Network interface
77 Controller
79 Memory
81 Operating system
83 Communications control module

What is claimed is:

1.-12. (canceled)

13. A control method for an access network node, the control method comprising:
communicating with a user equipment, UE, via multiple Protocol Data Unit, PDU, sessions; and
selecting another access network node for transferring at least one of the multiple PDU sessions while maintaining a service on the at least one of the multiple PDU sessions, based on at least one of:
network slices on which the multiple PDU sessions are established,
network slices which are supported by at least one cell operated by the another access network node,
user activity of the UE in the at least one of the multiple PDU sessions,
priority among network slices on which the multiple PDU sessions are established,
priority among the multiple PDU sessions,
priority among at least one active PDU session of the multiple PDU sessions,
priority among at least one PDU session which is supported by the at least one cell operated by the another access network node, and
user consent information received from the UE.

14. The control method according to claim 13, wherein
the selecting includes selecting the another access network node based on the network slices which are supported by the at least one cell operated by the another access network node, and the control method further comprises:
receiving the network slices which are supported by the at least one cell operated by the another access network node, from the another access network node on an inter-access network node interface setup procedure.

15. The control method according to claim 13, wherein
the selecting includes selecting the another access network node based on the priority among the multiple PDU session, and
the priority among the multiple PDU sessions is mapped to each of the multiple PDU sessions.

16. The control method according to claim 14, wherein
the priority among the multiple PDU sessions is mapped from at least one of priority among network slices with the multiple PDU session thereon and priority among at least one of closed access groups, CAGs, supported by at least one cell operated by the another access network node.

17. The control method according to claim 16, further comprising:
receiving the priority among the multiple PDU sessions from the UE, via an access stratum message or a non-access stratum message.

18. The control method according to claim 16, wherein
the at least one of the priority among the network slice and the priority among the at least one of CAGs is managed by a network function node for unified data.

19. The control method according to claim 16, wherein
the at least one of the priority among the network slice and the priority among the at least one of CAGs is assigned by a network function node for mobility management or a network function node for session management.

20. The control method according to claim 13, wherein
the transferring is occurred due to at least one of mobility of the UE, a handover, a cell change order, and a Radio Resource Control, RRC, connection release with re-direction.

21. The control method according to claim 13, wherein
the selecting includes selecting the another access network node, based on at least one of closed access groups, CAGs, supported by at least one cell operated by the another access network node and based on the membership or subscription of the UE for the at least one of CAGs.

22. The control method according to claim 21, wherein
the selecting includes selecting the another access network node, based on priority among the at least one of CAGs.

23. A control method for a user equipment, UE, the control method comprising:
communicating with an access network node, via multiple Protocol Data Unit, PDU, sessions; and
sending, to the access network node, at least one of:
user consent information; and
priority among the multiple PDU sessions, wherein
another access network node for transferring at least one of the multiple PDU sessions is selected by the access network node while maintaining a service on the at least one of the multiple PDU sessions, based on the at least one of the user consent information and the priority among the multiple PDU sessions.

24. A control method for a network function node, the control method comprising:
receiving, from a user equipment, UE, at least one of a Protocol Data Unit, PDU, session establishment request and a Service Request, including network slice information indicating network slices and multiple PDU session identifiers, IDs indicating multiple PDU sessions;
retrieving priority among the network slices, from a network function node for unified data;
mapping priority among the PDU sessions and the priority among the network slices; and
sending the priority among the PDU sessions to the access network node, wherein
at least one of the priority among the PDU sessions and the priority among the network slices is used for transferring at least one of the multiple PDU sessions while maintaining a service on the at least one of the multiple PDU sessions.
